(19) United States
(12) Patent Application Publication
(10) Pub. No.: US 2010/0129140 A1
(43) Pub. Date: May 27, 2010

(54) CONNECTOR FOR A LIQUID COOLING SYSTEM IN A COMPUTER

(75) Inventor: GEOFF SEAN LYON, CALGARY (CA)

Correspondence Address: BENNETT JONES LLP;C/O MS ROSEANN CALDWELL, 4500 BANKERS HALL EAST, 855 - 2ND STREET, SW, CALGARY, AB, T2P 4K7, CA

(73) Assignee: COOLIT SYSTEMS INC., Calgary (CA)

(21) Appl. No.: 12/347,309

(22) Filed: Dec. 31, 2008

Related U.S. Application Data
(60) Provisional application No. 61/118,359, filed on Nov. 26, 2008.

(51) Int. Cl. F16L 55/00

(52) U.S. Cl. 403/24; 285/23

(57) ABSTRACT

A connector and a connection system for a liquid cooling system for a computer are provided. The connector has a cylindrical base and a sealing ring encircling the base. A retaining channel is provided on the base to receive a retaining device. One of the components in the liquid cooling system has a liquid port with a cavity having an inner surface, an opening in fluid communication with the cavity and a fluid passage in fluid communication with the cavity. The base of the connector is sized to fit within the liquid port so that when the base is inserted in the liquid port, the sealing ring is forced against an inner surface of the liquid port, forming a seal between the sealing ring and the inner surface of the liquid port.

The present invention relates to a connector for a liquid-cooling system for a computer and more particularly to a connector for fluidly coupling an end of a section of tubing carrying cooling liquid to a component in a liquid cooling system for a computer.

### BACKGROUND OF THE INVENTION

Electrical components in computers (i.e. microprocessors, graphic cards, etc.) generate heat as they operate and some of this heat must be dissipated to keep the components operating properly. Allowing these electrical components to overheat or operate for long periods at elevated temperatures can adversely affect their performance (i.e. an overheating CPU can result in system freezes or crashes) and significantly shorten the life-span of the electrical components.

As electrical components in computer systems become more and more advanced, operating at ever increasing speeds, they also tend to generate more and more heat during their operation. Originally, air cooling was used to reduce the operating temperatures of electrical components in computer systems and air cooling systems are still the most common cooling system in computer systems today. In an air cooling system, air alone is used to cool electrical components with heat sinks used for components, such as the CPUs, that tend to generate more heat than other components. Typically, a fan is used to circulate air around the electrical components in the computer system.

While air cooling is sufficient to keep electrical components in many computer systems operating within acceptable temperature ranges, with the continuous development of ever higher performing computer components, liquid cooling systems for computers have been developed and made available. Liquid cooling systems use a liquid, such as water, to cool various electrical components, such as the CPU, in a computer system, especially those computer systems using high-end hardware or where components in the computer system have been set to run faster than recommended by the manufacturer (i.e. overclocked). Liquids, such as water, have a higher thermal capacity than air, allowing liquids to absorb and transfer more heat than air. This makes liquid cooling of electrical components more efficient than air cooling. While water or distilled water are commonly used as the cooling liquid in these systems, it will be appreciated that various liquid coolants, such as freon, alcohols, glycols, etc. are also known and used.

While liquid cooling systems for computers have the advantage of providing better cooling than more conventional air cooling systems, these systems are not without their disadvantages and one of their disadvantages is the use of liquid in close proximity to the electrical components. Under ideal circumstances, the cooling liquid is always contained within the cooling system so that the liquid never comes in contact with any of the electrical components of the computer system. However, if the cooling system is improperly installed or forms a leak, liquid from the cooling system may come in contact with electrical components in the computer, which can easily damage the components. Preventing leaks is a major focus with liquid cooling systems for computers and an improperly installed and connected liquid cooling system in a computer could be devastating.

### SUMMARY OF THE INVENTION

In a first aspect, a connector for connecting to a liquid port on a component of a liquid cooling system for a computer system is provided, the liquid port having a fluid passage. The connector comprising: a cylindrical base having a first end, a second end and an outer surface; a sealing channel in the outer surface of the base and encircling the base; a sealing ring provided in the sealing channel and extending past the outer surface of the base; and a retaining channel in the outer surface of the base to receive a retaining device. The base is sized to fit within the liquid port so that when the base is inserted in the liquid port, the sealing ring is forced against an inner surface of the liquid port, forming a seal between the sealing ring and the inner surface of the liquid port.

In another aspect, a connection system for a liquid cooling system for a computer is provided. The system comprises: a component of a liquid cooling system for a computer system, the component having a liquid port having a cavity with an inner surface, an opening in fluid communication with the cavity and a fluid passage in fluid communication with the cavity; and a connector having a cylindrical base having a outer surface, a retaining channel in the outer surface of the base to receive a retaining device, a sealing channel in the outer surface of the base encircling the outer surface, and a sealing ring positioned in the sealing channel and extending past the outer surface of the base. The base of the connector is sized to fit through the opening of the liquid port into the cavity of the liquid port so that the sealing ring is forced against the inner surface of the liquid port.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic pictorial view of a partially assembled tower-case personal computer with an embodiment of a liquid cooling system installed;

FIG. 2 is a perspective view of a connector for connecting components of a liquid cooling system for a computer;

FIG. 3 is a perspective view of a liquid port;

FIG. 4 is a top view of the connector of FIG. 1 inserted in the liquid port of FIG. 3;

FIG. 5 is a side sectional view of the connector and liquid port along line AA′ in FIG. 4;

FIG. 6 is a perspective view of a liquid port using a threaded aperture and a screw to hold a connector in place in the liquid port;

FIG. 7 is a perspective view of a liquid port using a biased ball detent to hold a connector in place in the liquid port;

FIG. 8 is a side view of an elbow-type connector in a further aspect, where a barb of the connector is at an angle to a base of the connector;

FIG. 9 is a side view of another elbow-type connector in a further aspect, where a barb of the connector is at an angle of approximately forty five degrees (45°) to a base of the connector;

FIG. 10 is side view of an adapter connector for connecting an end of a section of tubing to a connector, such as the connector of FIG. 2; and

FIG. 11 is a top view of the adapter connector of FIG. 10;

FIG. 12 is a side sectional view of the adapter connector of FIG. 10, along sectional line BB′ in FIG. 11; and

FIG. 13 is a side view of a plug in a further aspect for insertion into a liquid port.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

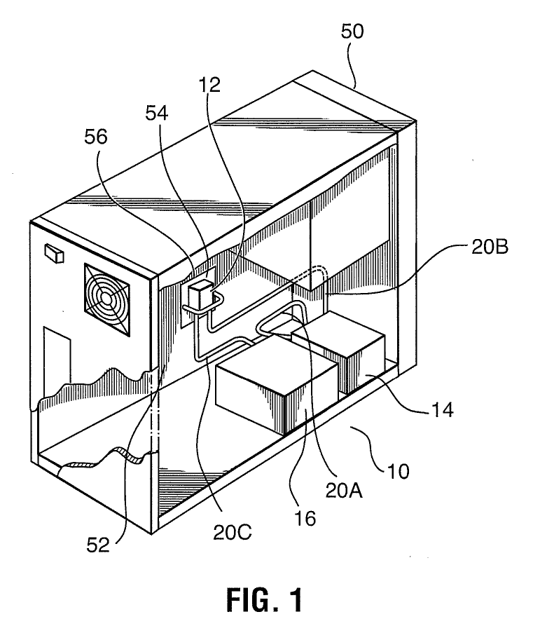

FIG. 1 illustrates a liquid cooling system 10 installed in a typical desktop personal computer (“PC”), generally indicated by reference numeral 50. In FIG. 1, PC 50 is a tower-style personal computer; however, a person skilled in the art will appreciate that other styles of computer, such as a desktop-style, rack server, etc., could have the liquid cooling system 10 installed. PC 50 is shown with the cover and power supply removed to better show the liquid cooling system 10. The PC 50 has a motherboard 52 containing a CPU microprocessor 54 mounted in a socket 56 in the motherboard 52. Other conventional components are omitted.

The liquid cooling system 10 has a heat exchanger 12, a liquid cooling module 14 and a pump module 16. A number of sections of tubing 20A, 20B, 20C are provided routing the cooling liquid between the heat exchanger 12, the liquid cooling module 14 and the pump module 16. The heat exchanger 12 is mounted in contact with the CPU microprocessor 54 so that heat generated by CPU microprocessor 54 can be transferred to liquid cooling passing through the heat exchanger 12. The liquid cooling module 14 could be a heat sink for passively or actively dissipating heat from the cooling liquid as it passes through the liquid cooling module 14 into the surrounding air. The pump module 16 circulates the cooling liquid through the liquid cooling system 10.

The liquid cooling module 14 is connected to the pump module 16 by a first tubing section 20A. A second section of tubing 20B connects the liquid cooling module 16 to the heat exchanger 12. The heat exchanger 12 is connected to the pump module 16 by a third section of tubing 20C.

In operation, the liquid cooling system 10 operates to absorb heat generated by the CPU microprocessor 54 in the cooling liquid where the heat is then removed from the cooling liquid by the liquid cooling module 14. The pump module 16 circulates the cooling liquid through the first tubing section 20A to the liquid cooling module 14, where the cooling liquid circulates through the liquid cooling module 14. Once the cooling liquid has passed through the liquid cooling module 14, it is routed through the second tubing section 20B to the heat exchanger 12 where the cooling liquid absorbs heat generated by the CPU microprocessor 54. The cooling liquid, heated by the CPU microprocessor 54, then passes from the heat exchanger 12 through the third section of tubing 20C back to the pump module 16. The cooling liquid is continuously circulated through the liquid cooling system 10, absorbing and releasing heat generated by the CPU microprocessor 54.

Although the liquid cooling system 10 illustrated in FIG. 1, has a single heat exchanger 12, a person skilled in the art will appreciate that more than one heat exchanger could be used to cool more than one electrical component in the PC 50 and that more than three sections of tubing 20A, 20B, 20C may be needed to implement a specific liquid cooling system for a computer.

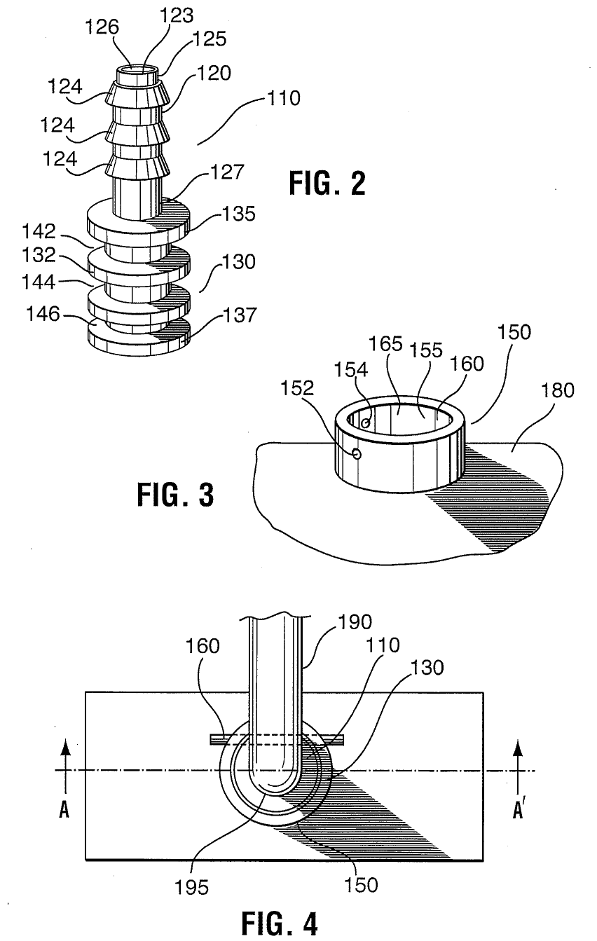

For the liquid cooling system 10 to be installed in the PC 50, the sections of tubing 20A, 20B, 20C have to be connected to the various components in the liquid cooling system 10. FIG. 2 illustrates a connector 110 for connecting a section of tubing (not shown) to a component (not shown) in a liquid cooling system for a computer, such as the liquid cooling system 10 shown in FIG. 1. The connector 110 has a barb 120 and a base 130.

The barb 120 has a first end 125, a second end 127 and is tubular in shape with a number of knurls 124 extending out from an outer surface 122 of the barb 120. The barb 120 is sized to allow an end of a section of tubing (not shown) to be slid and retained over the barb 120 with the knurls 124 on the barb 120 helping to secure the end of the section of tubing in position over the barb 120. Typically, the barb 120 is sized to be only slightly smaller than the tubing, so that the tubing is slightly stretched around the barb 120 when the tubing is slid in place over the barb 120. An opening 126 is provided at the first end 125 of the barb 120 leading to an inner passage 123 extending through the connector 110 so that cooling liquid from the section of tubing connected to the barb 120 can pass into the connector 110 through the opening 122 and into the inner passage 123.

In an aspect, the knurls 124 encircles the barb 120 and have a wedge shaped profile, starting at the outer surface 122 of the barb 120 and sloping outwards towards the second end 127 of the barb 120.

The base 130 has a first end 135 and a second end 137 and is connected at the first end 135 to the second end 127 of the barb 120. The base 130 is sized to mate with a liquid port (not shown) provided in a component (such as the heat exchanger 12, pump module 16 or liquid cooling module 14 of liquid cooling system 10 shown in FIG. 1 or some other component in a liquid cooling system for a computer). The base 130 has an outer surface 132 with a retaining channel 142, a first sealing channel 144 and a second sealing channel 146 provided in the outer surface 132. The first sealing channel 144 and the second sealing channel 146 completely encircle the base 130. The retaining channel 142 may completely encircle the base 130 or partially encircle only a portion of the base 130.

FIG. 3 illustrates a liquid port 150 in a component 180 for receiving the base 130 of the connector 110 shown in FIG. 2 to allow cooling liquid to enter the component 180. The component 180 could be the heat exchanger 12, pump module 16 or liquid cooling module 14 of liquid cooling system 10 shown in FIG. 1 or some other component in a liquid cooling system for a computer. The liquid port 150 has an opening 160 opening into a cavity 165 sized to accept the base 120 of the connector 110. The cavity 165 has an inner surface 155. A first aperture 152 and a second aperture 154 pass through the liquid port 150 into the cavity 165. The first aperture 152 and second aperture 154 are aligned so that when a retaining device (not shown), such as a pin, which can be in the form of a threaded fastener, a rod, a key, etc., is inserted through the first aperture 152 and into the cavity 165, the retaining device can also be slid through the second aperture 154.

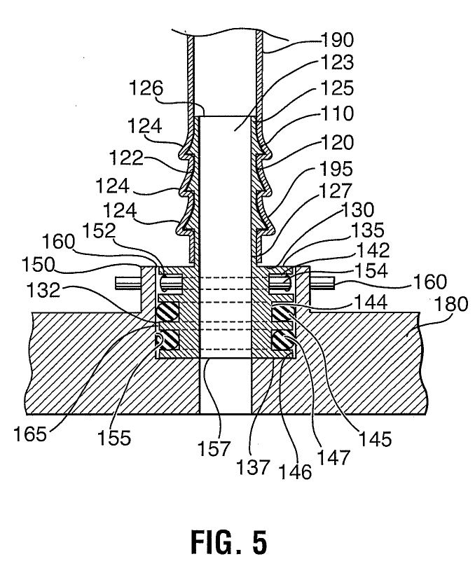

FIGS. 4 and 5 illustrate the connector 110 inserted into the liquid port 150 of the component 180, connecting an end 195 of a section of tubing 190 to the component 180. The base 130 of the connector 110 is positioned within the cavity 165 of the liquid port 150 with the barb 120 exposed and extending away from the liquid port 150.

The inner passage 123 of the connector 110 extends through the connector 110, passing through the barb 120 and the base 130 of the connector 110. This inner passage 123 aligns with a fluid passage 157 in the cavity 165 of the liquid port 150 in the component 180 allowing cooling liquid passing through the connector 110 to enter the component 180 through the fluid passage 157.

A first sealing ring 145 and a second sealing ring 147 are provided in the first sealing channel 144 and the second sealing channel 145, respectively, of the base 130 of the connector 110. The first sealing ring 145 in the first sealing channel 144 and the second sealing ring 147 provided in the second sealing channel 146 extend past the outer surface 132 of the base 130 of the connector 110 so that the first sealing ring 145 and the second sealing ring 147 contact the inner surface 155 of the cavity 165 of the liquid port 150. This contact between the first sealing ring 145, the second sealing ring 147 and the inner surface 155 of the cavity 165 of the liquid port 150, compresses the first sealing ring 145 and the second sealing ring 147, forming a liquid-tight seal, preventing cooling liquid that is passing into the cooling element 180 through the connector 110 from passing between the outer surface 132 of the base 130 of the connector 110 and the inner surface 155 of the cavity 165 of the liquid port 150 and leaking into the computer in which the liquid cooling system is installed in. Note that inner surface 155 may include a sealing surface such as a polished interval.

With the base 130 of the connector 110 inserted into the cavity 165 of the liquid port 150, the retaining channel 142 aligns with the first aperture 152 and the second aperture 154 in the liquid port 150 so that the first aperture 152 and the second aperture 154 open into the retaining channel 142. A retaining device 160 which in this embodiment is shown in the form of a pin is used to secure the base 130 of the connector 110 in the liquid port 150, preventing the connector 110 from being withdrawn from the liquid port 150 while the retaining device 160 is in place. The positioning and the alignment of the first aperture 152 and the second aperture 154 allow the retaining device 160, when it is passed through the first aperture 152 and second aperture 154, to pass through the retaining channel 142 of the base 130 of the connector 110 without being obstructed by the base 130 of the connector 110. With the retaining device 160 in place, passing through the first aperture 152, part of the retaining channel 142 and the second aperture 154, the connector 110 is secured in the liquid port 150 preventing the base 130 of the connector 110 from being withdrawn from the cavity 165 of the liquid port 150 while the retaining device 160 is in place. However, the retaining channel 142 allows the connector 110 to be rotated in the cavity 165 while the retaining device 160 is in place. The connector 110 can be rotated 360° or more if the retaining channel 142 completely encircles the base 130 or the range of rotation of the connector 110 can be limited by the length of the retaining channel 142 if the retaining channel 142 partially encircles only a portion of the base 130.

The retaining device 160 can be formed to be held in the first aperture 152 and the second aperture 154 by forming a close fit, forming in ends, providing caps, threading, barbs, etc. This forming inhibits the retaining device 160 from inadvertently being withdrawn from the first aperture 152 and/or the second aperture 154.

In operation, the connector 110 is used to connect an end 195 of a section of tubing 190 to the component 180. An end 195 of the section of tubing 190 to be connected to the component 180 is slid over the barb 120 of the connector 110. Because the section of tubing 190 is typically at least slightly elastic, the end 195 of the section of tubing 190 is stretched over the barb 120 with the slight stretching of the end 195 of the section of tubing 190 around the barb 120 and the knurls 124 helping to secure the end 195 of the section of tubing 190 in position over the barb 120. Additionally, in some installations a clamp, piece of tape, etc. is then placed around the end 195 of the section of tubing 190 covering the barb 120 to further aid in securing the end 195 of the section of tubing 190 in place over the barb 120. Adhesive may be used to secure the end 195 of the section of tubing 190 in place over the barb 120.

With the end 195 of the section of tubing 190 in position over the barb 120 of the connector 110, the connector 110 can be connected to the component 180 so that cooling liquid passing through the section of tubing 190 can pass into the component 180. To connect the section of tubing 190 to the component 180, the base 130 of the connector 110 is inserted through the opening 160 of the liquid port 650 and into the cavity 165 of the liquid port 150 in the component 180. The retaining device 160 is then inserted through the first aperture 152 and the second aperture 154, securing the connector 110 in place in the liquid port 150.

When cooling liquid passes through the section of tubing 190 and out the end 195 of the section of tubing 190, the cooling liquid will pass through the inner passage 123 of the connector 110 and into the component 180 through the fluid passage 157 in the bottom of the liquid port 150. The second sealing ring 147 and the first sealing ring 145 will prevent any of the cooling liquid from passing between the inner surface 155 of the cavity 165 and the outer surface 132 of the base 130 of the connector 110.

The connector 110 allows the end 195 of the section of tubing 190 to be relatively quickly connected to the component 180 and the first sealing ring 145 and second sealing ring 147 provide a substantially leak-free seal. The connector 110 can also be repeatedly removed and reconnected in the liquid port 150 without affecting the sealing between the connector 110 and the liquid port 150.

Because of the orientation of the retaining channel 142 and the retaining device 160, the connector 110 can be rotated relative to the liquid port 150 without having to remove the base 130 of the connector 110 from the liquid port 150. This can facilitate positioning and installation of a liquid cooling system without kinking or awkwardly bending the tubing connecting the components in the liquid cooling system.

The end 195 of the section of tubing 190 can be positioned over the barb 120 by a person installing the liquid-cooling system in a computer system. However, it is envisioned that in some circumstances the end of the section of tubing may be installed on the barb 120 of the connector 110 by the manufacturer of the liquid cooling system. This allows the manufacturer to ensure the end 195 of the section of tubing 190 is properly positioned over the barb 120, but still allow the installer to connect all the components in the liquid cooling system to the tubing based using the connectors 110.

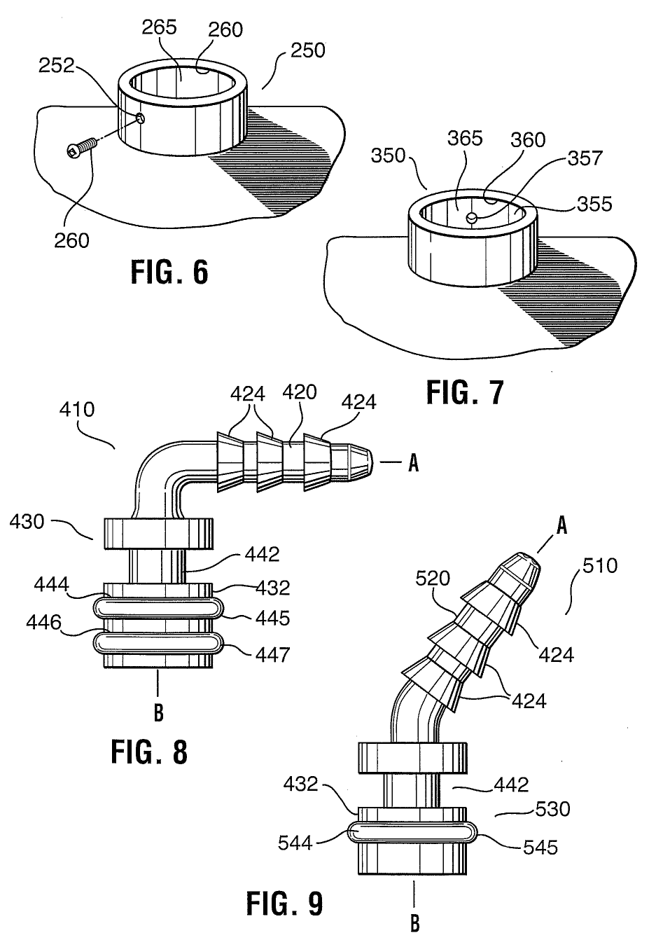

FIGS. 4 and 5 illustrate the retaining device 160 installed through the first aperture 152 and the second aperture 154 to hold the base 130 of the connector 110 in liquid port 150. However, various types of retaining devices can be used with the connector 110 to hold the base 130 of the connector 110 in a liquid port. FIG. 6 illustrates a liquid port 250 with an opening 260 leading to a cavity 265. A threaded aperture 252 and a retaining device in the form of a screw 260 is provided. The screw 250 is sized to thread into the threaded aperture 252 and secure a connector, such as connector 110 shown in FIG. 2, in the cavity 265. With the screw 260 threaded in the threaded aperture 252, the screw 260 extends into the retaining channel 142 of the connector 110 shown in FIG. 2, preventing the base 130 of the connector 110 from being withdrawn from the liquid port 250, but still allowing the connector 110 to be rotated relative to the liquid port 250. FIG. 7 illustrates a liquid port 350, having an opening 360 leading into a cavity 365, where a retaining device is provided in the form of a biased catch, such as a detent 357 on an inner surface 355 of the cavity 365 of the liquid port 350 and biased inwards from the inner surface 355 of the cavity 365 of the liquid port 350. The biased detent 357 is positioned on the inner surface 355 of the cavity 365 of the liquid port 350 so that the biased detent 357 protrudes into the retaining channel 142 on the base 130 of the connector 110 shown in FIG. 2, when the base 130 of the connector 110 is inserted in the cavity 365 of the liquid port 350, the biased detent 357 can be urged against its biasing force to allow the base 130 to pass in and out of the cavity 365. The biased detent 357 holds the base 130 in the cavity 365 of the liquid port 350, but allows the connector 110 to rotate relative to the liquid port 350. Alternatively, the biased catch can be in the form of a biased c-spring.

FIG. 8 illustrates a connector 410 in a further aspect. The connector 410 has a barb 420, with a number of knurls 424, and a base 430 with an outer surface 432, a retaining channel 442, a first sealing channel 444, a first sealing ring 445, a second sealing channel 446 and a second sealing ring 447. The barb 420 runs substantially along a first axis, A, and the base 430 runs substantially along a second axis, B, such that the connector takes the form of an elbow.

In operation, an end of a section of tubing (not shown) can be positioned over the barb 420 and the connector 410 inserted and secured in a liquid port of a component in a liquid cooling system (not shown). The direction of flow of cooling liquid exiting the end of the section of tubing and passing into the connector 410 is routed ninety degrees (90°) and before the flow of cooling liquid passes out of the connector 410 and into the component of the liquid cooling system. In this manner, connector 410 can be used when a sharp bend is needed to install the liquid cooling system and/or where a component of the liquid cooling system is installed close to another component in the computer system, preventing the tubing to be installed in a straight run directly into the component.

The connector 410 has the barb 420 at an angle of approximately ninety degrees (90°) from the base 430 to allow installations where a sharp bend is needed or desired, however, it will be appreciated that the barb 420 could be provided at various angles to the base 430. For example, FIG. 9 illustrates an elbow-type connector 510 having a barb 520 positioned at an angle less than ninety degrees (90°) from a base 530. Additionally, elbow-type connector 510 is illustrated in FIG. 8 having a single sealing channel 544 holding a single sealing ring 545.

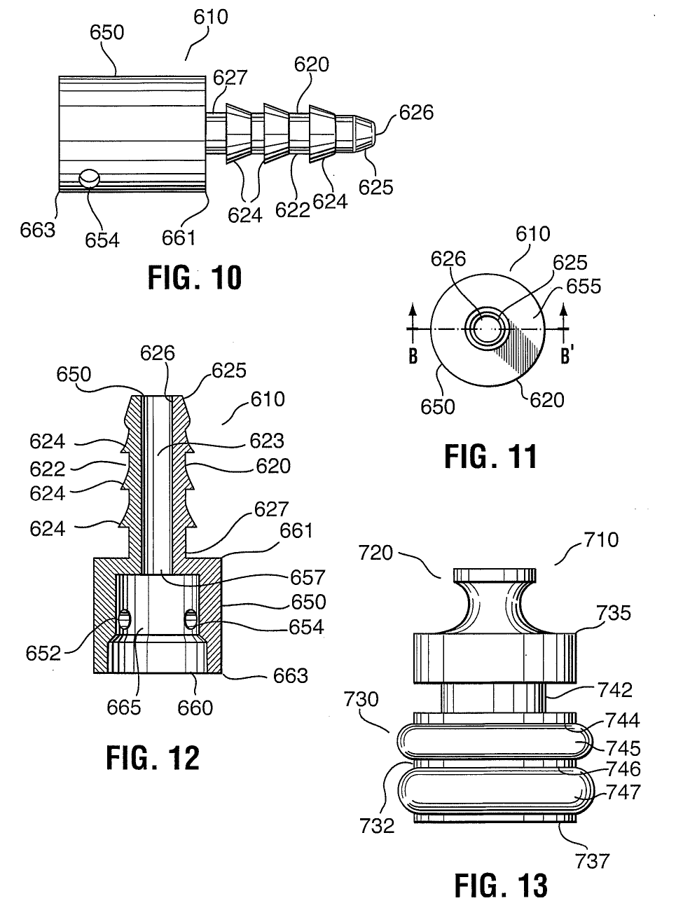

FIGS. 10, 11 and 12 illustrate an adapter connector 610 for connecting two sections of tubing (not shown). The adapter connector 610 has a barb 620, with a first end 625 and a second end 627, and a liquid port 650, with a first end 661 and a second end 663.

The barb 620 has a number of knurls 624 on an outer surface 622 of the barb 620 and is sized so that an end of a section of tubing (not shown) can be slid over the barb 620. An opening 656 on the first end 625 of the barb 620 opens into an inner passage 623 running through the barb 620.

The liquid port 630 has an opening 660 leading to a cavity 665 that is sized to accept the base of a connector, such as the base 130 of connector 110 shown in FIG. 2. A fluid passage 657 places the cavity 665 in fluid communication with the inner passage 623 of the barb 620.

A first aperture 652 and a second aperture 654 are provided passing into the cavity 665 of the liquid port 650, through which a retaining device (not shown) can be inserted holding a base of a connector in the cavity 665. A person skilled in the art will appreciate that adapter connector 650 could be altered so that other retaining devices, such as those illustrated in FIGS. 6 and 7, might be used with the adapter connector 610.

The adapter connector 610 allows a connector, such as the connector 110 shown in FIG. 2, to be connected to the adapter connector 610. In this manner, two sections of tubing (not shown) can be connected together. One section of tubing is connected to the barb 620 of the adapter connector 610 and the other section of tubing is connected to the barb 120 of the connector 110. The two sections of tubing can then be connected by inserting the base 130 of the connector 110 through the opening 660 of the cavity 665 of the liquid port 650 and secured in place by inserting a retaining device (not shown), such as a pin, through the first aperture 652 and the second aperture 654 to extend through the retaining channel 142 on the base 130 of the connector 110. In this manner, liquid coolant flowing out of the one section of tubing and through the inner passage 623 of the adapter connector 610 will pass through the fluid passage 657, into the inner passage 123 of the connector 110 and into the other section of tubing position over the barb 120 of the connector 110. Additionally, the adapter connector 610 could be used to transmit liquid coolant in the opposite direction, from a section of tubing connected to a connector 110, through the adapter connector 610 and into the other section of tubing connected to the adapter connector 610.

In some aspects, a component in a liquid cooling system may be provided with a number of liquid ports to allow the liquid cooling system to be installed in various different configurations. For some installations, fewer liquid ports may be needed than the number provided on the component, however, each of these liquid ports will have a fluid passage in them that could allow liquid coolant to flow out of the open liquid port if it is not in use. Therefore, in these cases a plug connector might be used to block the unneeded liquid ports. FIG. 13 illustrates a plug connector 710 for insertion into a liquid port, such as the liquid port 150 in FIG. 3. Because the liquid port 150 has a fluid passage 157 in fluid communication with cooling liquid passing through the component 180 of the liquid cooling system, if the liquid port 150 is not used, the plug connector 710 can be inserted in the cavity 165 of the liquid port 150 to plug the liquid port 150.

The plug connector 710 has a base 730 and a top 720. The base 730 has a first end 735, a second end 737 and an outer surface 732. The base 730 is sized to fit inside a cavity of a liquid port (not shown) provided in a component (such as the heat exchanger 12, pump module 16 or liquid cooling module 14 of liquid cooling system 10 shown in FIG. 1 or some other component in a liquid cooling system for a computer). The base 730 has an outer surface 732 with a retaining channel 742, a first sealing channel 744 and a second sealing channel 746 provided in the outer surface 732. A first sealing ring 745 and a second sealing ring 747 are provided in the first sealing channel 744 and the second sealing channel 746, respectively, such that the first sealing ring 745 and the second sealing ring 747 extend beyond the outer surface 732 of the base 730. A bottom surface 739 of the base is unperforated.

In operation, the plug connector 710 is inserted into a liquid port, such as the liquid port 150 shown in FIGS. 3 and 4. The first sealing ring 745 and second sealing ring 747 are forced against the inner surface 155 of the cavity 165 of the liquid port 150, forming a liquid-tight seal. The retaining device 160 is then used to hold the plug connector 710 in the cavity 165 of the liquid port 150. The unperforated bottom surface 739 of the base 730, the first sealing ring 745 and the second sealing ring 747 prevent cooling liquid from escaping out the fluid passage 157 of the component 180, past the base 730 of the plug connector 710 and into the interior of the computer system the component 180 is installed in.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A connector for connecting to a liquid port on a component of a liquid cooling system for a computer system, the liquid port having a fluid passage, the connector comprising:
a cylindrical base having a first end, a second end and an outer surface;
a sealing channel in the outer surface of the base and encircling the base;
a sealing ring provided in the sealing channel and extending past the outer surface of the base; and
a retaining channel in the outer surface of the base to receive a retaining device,
wherein the base is sized to fit within the liquid port so that when the base is inserted in the liquid port, the sealing ring is forced against an inner surface of the liquid port, forming a seal between the sealing ring and the inner surface of the liquid port.

2. The connector of claim 1 further comprising:
an additional sealing channel encircling the outer surface of the base; and
an additional sealing ring provided in the additional sealing channel and extending past the outer surface of the sealing channel.

3. The connector of claim 1 where the retaining device is a pin that when inserted through a first aperture and a second aperture in the liquid port, extends into the retaining channel.

4. The connector of claim 1 wherein the retaining device is a screw, that when threaded through a threaded aperture in the liquid port, extends into the retaining channel.

5. The connector of claim 1 wherein the retaining device is a biased ball detent that is biased into the retaining channel when the base of the connector is inserted in the liquid port.

6. The connector of claim 2 wherein the retaining channel is positioned between the first end of the base and the sealing channel.

7. The connector of claim 1 wherein the retaining channel encircles the base.

8. The connector of claim 1, further comprising:
a tubular barb having a first end, a second end, at least one knurl on an outer surface of the barb, and an opening at the first end of the barb, wherein the second end of the barb is connected to the base;
an opening in the base positioned to align with the fluid passage of the liquid port when the base of the connector is inserted in the liquid port; and
an inner passage running through the connector from the opening at the first end of the barb to the opening in the base.

9. The connector of claim 8 wherein the at least one knurl encircles the barb and has a wedge-shaped profile, sloping outwards from the outer surface of the barb, toward the second end of the barb.

10. The connector of claim 8 wherein the base substantially defines a first axis and the barb substantially defines a second axis, the first axis inline with the second axis.

11. The connector of claim 8 wherein the base substantially defines a first axis and the barb substantially defines a second axis, the second axis at an angle to the first axis.

12. The connector of claim 11 where the second axis is substantially perpendicular to the first axis.

13. The apparatus of claim 1 wherein the base has an unperforated bottom surface.

14. A connection system for a liquid cooling system for a computer, the system comprising:
a component of a liquid cooling system for a computer system, the component having a liquid port having a cavity with an inner surface, an opening in fluid communication with the cavity and a fluid passage in fluid communication with the cavity; and
a connector having a cylindrical base having a outer surface, a retaining channel in the outer surface of the base to receive a retaining device, a sealing channel in the outer surface of the base encircling the outer surface, and a sealing ring positioned in the sealing channel and extending past the outer surface of the base,
wherein the base of the connector is sized to fit through the opening of the liquid port into the cavity of the liquid port so that the sealing ring is forced against the inner surface of the liquid port.

15. The connection system of claim 14 further comprising:
an additional sealing channel encircling the outer surface of the base of the connector; and
an additional sealing ring provided in the additional sealing channel of the connector.

16. The connection system of claim 1 wherein the retaining device is a pin and the liquid port has a first aperture and a second aperture passing into the cavity, the first aperture and second aperture being aligned so that when the base of the connector is inserted into the cavity of the liquid port and the retaining device is slid through the first aperture and the second aperture, the retaining device extends through the retaining channel of the base of the connector.

17. The connection system of claim 14 wherein the liquid port has a threaded aperture opening into the cavity and the retaining device is a screw and wherein when the base of the connector is inserted in the cavity of the liquid port and the retaining device is screwed through the threaded aperture, the retaining device extends into the retaining channel of the base of the connector.

18. The connection system of claim 14 wherein the retaining device is a biased ball detent provided on the inner surface of the cavity of the connector, the biased ball detent positioned so that the bias ball detent extends into the retaining channel of the base of the connector when the base of the connector is inserted in the cavity of the liquid port.

19. The connecting system of claim 14 wherein the retaining channel is positioned between the top of the base of the connector and the sealing channel of the connector.

20. The connection system of claim 14 wherein the retaining channel encircles the base of the connector.

21. The connection system of claim 14, wherein the connector has a tubular barb having a first end, a second end, at least one knurl on an outer surface of the barb and an opening at the first end of the barb, wherein the second end of the barb is connected to the base;
wherein an opening is provided in the base, the opening in the base positioned to align with the fluid passage of the liquid port when the base of the connector is inserted in the liquid port,
wherein an inner passage is provided running through the connector from the opening at the first end of the barb to the opening in the base,
and wherein an end of section of tubing can be positioned over the barb of the connector.

22. The connector of claim 8 wherein the base defines a first axis and the barb defines a second axis, the first axis inline with the second axis.

23. The connector of claim 8 wherein the base defines a first axis and the barb defines a second axis, the second axis at an angle to the first axis.

24. The connection system of claim 14 wherein the base of the connector has an unperforated bottom surface.
